(19) United States
(12) Patent Application Publication
(10) Pub. No.: US 2025/0075830 A1
(43) Pub. Date: Mar. 6, 2025

(54) HOLDER, IN PARTICULAR CABLE HOLDER

(71) Applicant: Siemens Aktiengesellschaft, München (DE)

(72) Inventors: Robert Lehmann, Leipzig (DE); Julius Adomeit, Berlin (DE)

(21) Appl. No.: 18/822,664

(22) Filed: Sep. 3, 2024

(30) Foreign Application Priority Data
Aug. 31, 2023 (DE) 10 2023 208 389.2

(51) Int. Cl. F16L 3/11; F16L 3/10

(52) U.S. Cl. CPC F16L 3/11; F16L 3/1091

(57) ABSTRACT

A holder has at least one holding section for receiving, guiding and/or holding at least one elongated object, and one fastening section. The fastening section contains a cord holder, which is a self-fixing, in particular self-clamping, configuration. A second aspect relates to a charging column having a charging cable, a cord hanger arrangement and at least one holder according to the first aspect of the invention.

### CROSS-REFERENCE TO RELATED APPLICATION

This application claims the priority, under 35 U.S.C. § 119, of German Patent Application DE 10 2023 208 389.2, filed Aug. 31, 2023; the prior application is herewith incorporated by reference in its entirety.

### FIELD AND BACKGROUND OF THE INVENTION

The invention relates to a holder for an object, in particular an elongated object, e.g. a line, a pipe, a cable or the like.

Holders for cables, pipes and lines are widely known. Holders of this kind can be secured by a flange, a bracket, a hook or the like, for example. Rope clamps, by means of which the holder can be secured or held on a wall or a support, for example, are also known.

### SUMMARY OF THE INVENTION

It is the underlying object of the invention to provide a holder of simple construction for an object, the holder containing a small number of components.

According to the invention, the object is achieved by a holder which contains at least one holding section for receiving, guiding and/or holding at least one object, in particular a charging cable, and at least one fastening section for the holder. The fastening section contains a cord holder, which is self-fixing, in particular of a self-clamping, design.

Advantageous refinements of the invention are the subject matter of the dependent claims.

The advantages that are achieved with the invention consist, in particular, in that the holder is of simple construction and contains a maximum of two or three components. For example, the holder can be formed just by a housing and the cord holder or by two housing parts and the cord holder.

The holder can be a single holder or a multiple holder, for example. In particular, the holder can be configured as a single-cable holder for receiving, guiding and/or holding a single cable. Alternatively, the holder can be configured as a multi-cable holder for receiving, guiding and/or holding a plurality of cables.

The holding section of the holder can be configured, for example, for receiving, guiding and/or holding an elongated object, e.g. a line, a pipe or a cable. The object can be held loosely and with limited capacity for movement or with a clamping action and in a fixed location by means of the holder, for example. The object, in particular an elongated object, e.g. a cable, e.g. a charging cable or power cable, can be of flexible, flexural stiff or pliable design.

The fastening section, which is configured as a cord holder, allows simple and time-saving mounting of the holder on a wall, a support or a grating, for example. The fastening section is integrated into the holder. Alternatively or in addition, the cord of the fastening section can be provided for the arrangement and guidance of the elongated object, in particular a cable, e.g. a charging cable.

In one possible embodiment, the cord holder is configured to fix a cord, in particular a loose fastening cord or guide cord, with a clamping action by the imposition of a load.

Another embodiment envisages that the holder has two half bodies, which, in the assembled state, form an overall hollow body having the holding section and the fastening section. For example, the half-bodies are configured as half shells that can be connected to one another. For example, the two half bodies can be screwed, clipped or clamped to one another.

In another possible embodiment, at least one of the half bodies can comprise at least two clamping bodies in the fastening section, the clamping bodies being configured, when a load is imposed, to fix the cord, in particular the fastening cord or guide cord, between these clamping bodies with a clamping action and/or to fix it in a fixed position (also referred to as a fixed location) on these clamping bodies.

For example, a first clamping body can be arranged at a fixed location in the fastening section. The first clamping body can be configured as a cord guiding body, for example. Furthermore, it is possible for a second clamping body to be capable of being placed loosely in the fastening section before the cord is fixed with a clamping action. In particular, the second clamping body is a separate body, which is inserted or placed in the fastening section, for example.

For example, it is possible for the second clamping body to be capable of being placed or inserted in a noose of the cord placed in the fastening section.

A further development envisages that the clamping bodies are formed in the fastening section and arranged relative to one another in such a way that the cord is guided in a meandering way around these clamping bodies. In particular, the cord can be guided without knots by means of the clamping bodies and, after the imposition of a load, can be clamped without knots and fixed in a fixed location. The clamping bodies can comprise outer contours that correspond to one another, for example. For example, the clamping bodies can each have an identical or similar drop shape, triangular shape, oval shape or the like.

In another embodiment, each half body can have an axially extending, semicircular longitudinal opening. In the assembled and optionally connected state of the half bodies, the longitudinal opening can form a holding opening for the at least one object to be held, in particular an elongate object, e.g. a cable.

A second aspect of the invention relates to a charging column for an electric vehicle. The charging column contains a charging cable, a cord hanger arrangement and at least one holder according to the first aspect of the invention in an embodiment comprising a cord. The charging cable is thus arranged partially in the holding section of the at least one holder. A free end of the cord of the at least one holder is secured on the cord hanger arrangement. For example, the charging cable can be provided with a respective holder at several points along its main direction of extent, with the result that there is a free length of the charging cable remaining between adjacent holders.

The cord hanger arrangement can be equipped, for example, with joints or hinges, which allow extension of the cord hanger arrangement in response to a pulling force acting on the charging cable. This makes it possible for a person to grab a charging plug arranged on the end of the charging cable and pull it to the charging terminal on their electric vehicle, whereupon the charging cable and the cord hanger arrangement follow the person in a way that is relatively free of force. During this process, the person has only to apply the pulling force required to extend the cord hanger arrangement but not to manage the possibly heavy weight of a charging cable designed for high charging power levels. For example, the joints or hinges are designed in such a way that they cause a restoring force that brings about contraction and retraction of the charging cable when the pulling force is removed.

Other features which are considered as characteristic for the invention are set forth in the appended claims.

Although the invention is illustrated and described herein as embodied in a holder, in particular a cable holder, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a holder formed from two half bodies;

FIG. 2 is a perspective view of a half body of the holder;

FIG. 3 is a plan view of a fastening section from the inside with an inserted cord before insertion of a loose clamping body, in a partial view of a half body of the holder;

FIG. 4 is a plan view of the fastening section according to FIG. 3 with an inserted loose clamping body;

FIG. 5 is a plan view of the fastening section in a closed state;

FIG. 6 is an illustration showing an imposition of a load on the closed fastening section; and

FIG. 7 is a plan view of the fastening section when opened and from the inside after the imposition of a load.

In the figures, parts corresponding to one another have been provided with the same reference signs.

### DETAILED DESCRIPTION OF THE INVENTION

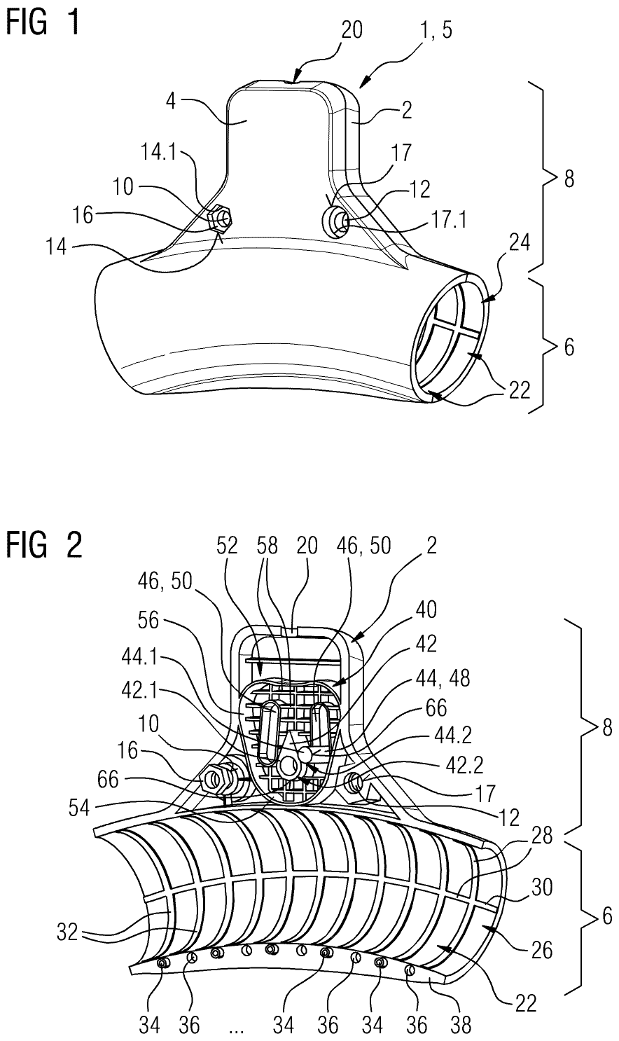

Referring now to the figures of the drawings in detail and first, particularly to FIG. 1 thereof, there is shown a perspective view of a holder 1 for receiving, guiding and/or holding at least one object (not illustrated specifically). In particular, the object can be an elongated object, e.g. a cable, e.g. a charging cable, power cable, ground cable or the like, a line, e.g. a power line or the like, or a pipe. The object can be of flexural stiff or pliable configuration. The object can be of flexible design.

The holder 1 can be configured as a single holder for a single object or as a multiple holder for a plurality of objects. The holder 1 can be configured as a cable holder, a line holder or a pipe holder. If configured as a cable holder, the holder 1 can also be referred to as a cable clamp.

The holder 1 can be formed from two half bodies 2, 4. The two half bodies 2 and 4 can be of mirror-symmetrical construction with respect to one another, for example. Furthermore, the two half bodies 2 and 4 can also be constructed as common parts, in particular identical common parts.

The holder 1 has a holding section 6 and a fastening section 8.

In the assembled state, the two half bodies 2 and 4 form an overall hollow body 5 having the holding section 6 and the fastening section 8. For example, the half bodies 2 and 4 are designed as half shells that can be connected to one another. For example, the two half bodies 2 and 4 can be screwed, clipped or clamped to one another.

The holding section 6 of the half body 2 is designed for receiving, guiding and/or holding the at least one object.

The fastening section 8 can comprise, for example, at least one, preferably two, through openings 10, 12, which are used to connect the two half bodies 2, 4, e.g. by means of a screw connection or riveted connection or the like.

At least in the entry region, one of the through openings 10 can comprise a recess 14, into which, for example, a nut 16, in particular a square nut or a hexagon nut, can be inserted or integrated, in particular said nut being embedded. The recess 14 has a larger diameter than the associated through opening 10. For this purpose, the recess 14 has a corresponding polygonal inner contour 14.1.

At least in the entry region, the other through opening 12 can comprise a further recess 17, into which a screw head can be screwed. For this purpose, the further recess 17 has a corresponding further inner contour 17.1. The recess 17 has a larger diameter than the associated through opening 12.

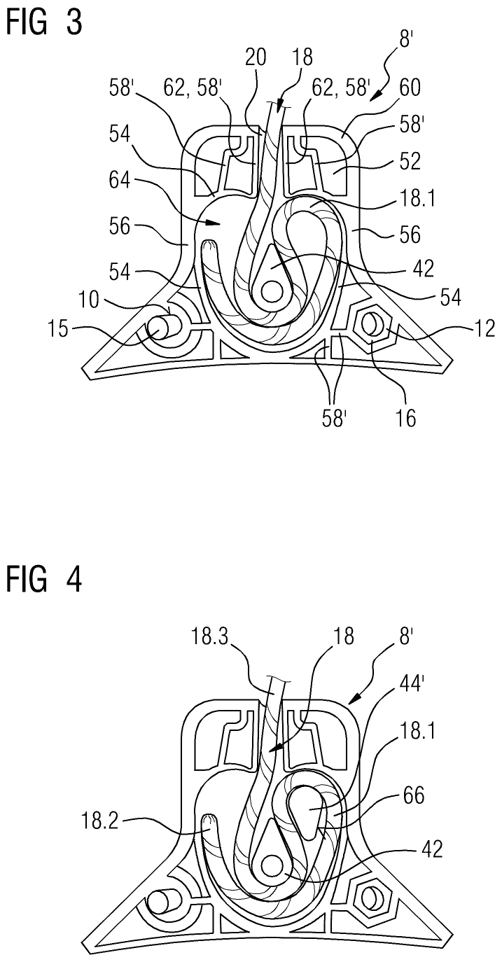

In addition, the fastening section 8 can be used to receive and fix a cord 18, illustrated in FIG. 3. For this purpose, the fastening section 8 has an exit opening 20 for the cord 18.

Each half body 2 and 4 has an axially extending semicircular longitudinal opening 22 in the holding section 6. In the assembled and optionally connected state of the half bodies 2 and 4, the respective longitudinal opening 22 can form a holding opening 24 for the at least one object to be held.

FIG. 2 schematically shows a perspective view of one of the half bodies 2 of the holder 1. The half body 2 will be described in detail by way of example below. The other half body 4 is of analogous construction. The following description thus also applies to half body 4.

The holding section 6 can be configured, for example, for receiving, guiding and/or holding an elongate object, e.g. a line, a pipe or a cable. The object can be supported or held loosely and with limited capacity for movement, in particular longitudinal movement and/or radial movement, or with a clamping action and in a fixed location by means of the holder 1, for example. The object, in particular an elongated object, e.g. a cable, e.g. a charging cable or power cable, can be of flexible, flexural stiff or pliable design.

The holding section 6 can be provided with an inner profile 26, in particular with ribs 28, e.g. longitudinal ribs 30 and circumferential ribs 32, as illustrated. The inner profile 26 serves to provide strength to the holding section 6, for example. With such a design of the half body 2, the object can be supported loosely and, in particular, with the ability for longitudinal movement and limited radial movement in the holder 1.

Alternatively or in addition, a clamping unit (not illustrated) or a fixing unit (not illustrated) can be provided in the holding section 6 for fixed-location support of the object in the holder 1.

In addition, the half body 2 can be equipped with pins 34 and pin openings 36 for plug connection between the two half bodies 2 and 4.

The pins 34 and the pin openings 36 are arranged alternately, for example, on or in a wall 38, in particular on or in a front face of the wall 38 of the half body 2, along the longitudinal opening 22 of the half body 2. In particular, the pins 34 (also referred to as plugs) and pin openings 36 (also referred to as sockets) are arranged in that wall 38 of the half body 2 which lies opposite the fastening section 8.

The fastening section 8 contains a cord holder 40. The fastening section 8 allows simple and time-saving mounting of the holder 1, e.g. on a wall, a support or a grating (not illustrated specifically).

The fastening section 8 is integrated into the holder 1.

The cord holder 40 can be provided in each of the half bodies 2 and 4 or alternatively only in one of the half bodies 2 or 4.

The cord holder 40 for the half body 2 is described below. If the cord holder 40 is also provided in the fastening section 8 of the half body 4, this is also of analogous construction.

The cord holder 40 serves to receive and fix the cord 18 (illustrated in FIG. 3) in the holder 1. In addition, the cord 18 can be provided for the arrangement and guidance of the elongate object, in particular a cable, e.g. a charging cable.

The cord holder 40 contains, for example, a first clamping body 42, which is arranged at a fixed location in the fastening section 8. The first clamping body 42 is designed as a cord guiding body 42.1, for example. In particular, the first clamping body 42 can comprise a deflecting section 42.2, e.g. a round contour section, an oval contour section or the like, for a cord deflection. The first clamping body 42 can have a drop-shaped outer contour 66 for cord guidance and/or cord deflection, for example.

The cord holder 40 contains a second clamping body 44, for example. In the exemplary embodiment according to FIG. 2, the second clamping body 44 is arranged movably in the fastening section 8.

The cord holder 40 can have one or more guides 46 for the second clamping body 44, for example. In the example according to FIG. 2, two guides 46 are provided. The respective guide 46 extends, in particular, approximately perpendicularly to the longitudinal extent of the holding section 6, in particular approximately perpendicularly to the longitudinal opening 22. The guides 46 are each designed as an elongate slot 50, for example.

The second clamping body 44 can be inserted into one of the guides 46 and moved along the elongate slot 50. The second clamping body 44 is configured as a pin 48, for example.

The second clamping body 44 is configured as a cord guiding body 44.1, for example. The second clamping body 44 has a deflecting section 44.2, e.g. a round contour section, an oval contour section or the like, for a cord deflection. The second clamping body 44 is configured as a cylindrical pin 48 with a circular outer contour 66, for example.

The cord holder 40 is formed in a receptacle 52 in the fastening section 8. The receptacle 52 is of shell-shaped design. The receptacle 52 is configured in such a way that the cord 18 can be supported flush in said receptacle.

The cord holder 40 can have an at least partially encircling inner wall 54. The inner wall 54 and/or an outer wall section 56 of the half body 2 serves as a boundary surface or contact surface for the cord 18.

In addition, a number of reinforcing ribs 58, in particular vertical ribs and/or transverse ribs, can be arranged in the receptacle 52, e.g. crosswise. The reinforcing ribs 58 are arranged within the cord holder 40, in particular within the inner wall 54.

The half body 2 is an injection molding, in particular a plastic injection molding. The fastening section 8 with the through openings 10, 12, the reinforcing ribs 58, the cord holder 40 with the guides 46, the fixed-location first clamping body 42, the inner wall 54 and the holding section 6 with the longitudinal opening 22 and the inner profile 26 as well as the pins 34 and the pin openings 36 is integrated into the half body 2, and these are formed, in particular shaped, during the injection molding process.

Nuts 16, in particular metal nut elements, and/or screw-fastening elements 15, in particular threaded bolts or screws, can be molded or embedded into the through openings 10, 12 in the fastening section 8.

The exit opening 20 is formed as a semicircular recess in the half body 2.

FIG. 3 schematically shows a partial plan view of an alternative fastening section 8′ of the half body 2 from the inside. The holding section 6 is not illustrated.

The fastening section 8′ differs from the fastening section 8 according to FIG. 8 in that no guides 46 and therefore no slots 50 and no pin 48 are provided.

In analogous fashion, the fastening section 8′ comprises the fixed-location first clamping body 42, in particular a drop-shaped first clamping body 42. In analogous fashion, the inner wall 54 is arranged in the receptacle 52 of the fastening section 8′.

In addition, the fastening section 8′ differs in respect of the reinforcing ribs 58′. The reinforcing ribs 58′ according to FIG. 3 are arranged between the inner wall 54 and an outer wall 60 of the fastening section 8′. There are fewer but thicker reinforcing ribs 58′ between the inner wall 54 and the outer wall 60. In other words: the reinforcing ribs 58′ are arranged outside the cord holder 40 in the fastening section 8′.

In the region of the semicircular exit opening 20 for the cord 18, two of the reinforcing ribs 58′ can be designed as guide ribs 62.

In analogous fashion, as described in FIG. 2, nuts 16, in particular metal nut elements, and/or screw-fastening elements 15, in particular threaded bolts or screws, can be molded or embedded into the through openings 10, 12 in the fastening section 8′.

FIG. 3 shows the cord inserted in the fastening section 8′. The cord 18 is laid loosely around the first clamping body 42. In particular, the cord holder 40, in particular the inner wall 54 thereof, is shaped and dimensioned in such a way that the cord 18 can be or is placed in the form of a loop or noose 18.1 and in a meandering way in the cord holder 40 before insertion of a loose second clamping body 44′ (illustrated in FIG. 4).

In particular, the cord holder 40 is configured to fix the cord 18, in particular a loose fastening cord or guide cord, with a clamping action due to the imposition of a load, as described in greater detail by way of example below.

The following description of the fixing with a clamping action applies to both embodiments shown in FIG. 2 (second clamping body 44 movable in the guide 46) and FIG. 3 (loosely insertable second clamping body 44′).

By virtue of the loose arrangement of the second clamping body 44′ in the cord holder 40, a cord receiving space 64 formed within the inner wall 54 and the outer wall sections 56 is formed without ribs. In other words: no reinforcing ribs 58′ are provided in this cord receiving space 64.

FIG. 4 schematically shows a plan view of the fastening section 8′ according to FIG. 3 with the inserted loose second clamping body 44′.

The second clamping body 44′ is a separate component. The second clamping body 44′ has an outer contour 66 corresponding to the first clamping body 42. In particular, both clamping bodies 42 and 44′ are of drop-shaped design.

The second clamping body 44′ is placed in the loose noose 18.1 of the cord 18.

A first cord end 18.2 of the cord 18 is arranged freely in the cord holder 40. A second cord end 18.3 is passed out of the exit opening 20 and is used to fasten the holder 1.

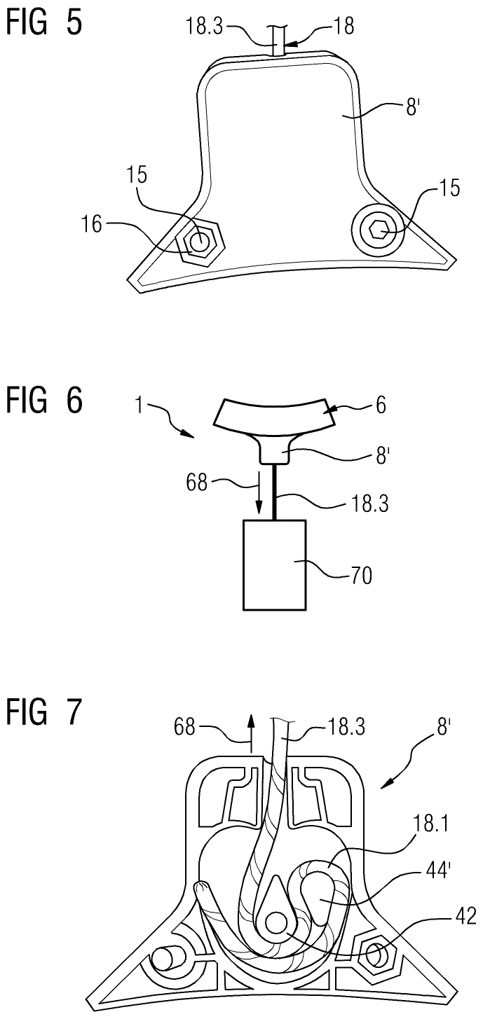

FIG. 5 schematically shows a plan view of the fastening section 8′ in the closed state and without the holding section 6.

The two half bodies 2 and 4 are connected to one another by means of screw-fastening elements 15 and nuts 16.

The second cord end 18.3 projects out of the exit opening 20 of the holder 1 (illustrated in FIG. 1).

FIG. 6 schematically shows the imposition of a load according to arrow 68 on the holder 1 in the closed state with the fastening section 8′ (or alternatively fastening section 8) and the holding section 6. This is a test construction, in which the fastening section 8′ of the holder 1 is tested in respect of the self-clamping cord holder 40.

Alternatively, the cord holder 40 of the holder 1 can self-fix the cord 18 by means of such a load buildup during production. In particular, the cord holder 40 is configured to fix the cord 18 in the fastening section 8′ with a clamping action by the imposition of a load in accordance with arrow 68.

Alternatively, it is possible, in normal use, when fastened on a frame, on a wall or on a support with the received elongate object, for the holder 1 and, in particular, the cord holder 40 to be configured to self-fix, in particular self-clamp, the cord 18. In other words: the cord holder 40 is of self-fixing, in particular self-clamping, design.

The holder 1 is a simple construction and contains the two half bodies 2 and 4 as two housing parts with an integrated cord holder 40 and the cord 18 (example according to FIG. 2) and optionally in addition the loose second clamping body 44′ (example according to FIG. 3).

For self-fixing, in particular self-clamping, of the cord 18 in the cord holder 40, the second cord end 18.3 is subjected to a predetermined load 70, as illustrated in FIG. 6.

FIG. 7 schematically shows a plan view of the fastening section 8′ when opened and from the inside after being subjected to a load by the load 70 in accordance with arrow 68 (illustrated in FIG. 6).

The two clamping bodies 42 and 44′ (alternatively 42 and 44) described above are configured in such a way and interact with one another in such a way during the imposition of a load in accordance with arrow 68 that the cord 18 is fixed with a clamping action, in particular is clamped, and/or is fixed in position (location) on these clamping bodies 42 and 44′ (or 42 and 44).

The imposition of a load in accordance with arrow 68 tightens the noose 18.1 and, in the process, takes along the loose second clamping body 44′ (example according to FIG. 3) or the movable second clamping body 44 (example according to FIG. 2) and moves this in the direction of the fixed-location first clamping body 42, with the result that the cord 18 is clamped and/or fixed in position between the two clamping bodies 42 and 44′ (as illustrated in FIG. 7) or 42 and 44 (not illustrated).

In this case, the cord 18 is laid around the two clamping bodies 42 and 44′ (or 42 and 44) without knots, in particular in a meandering way.

Although the invention has been illustrated and described in detail by preferred exemplary embodiments, the invention is not limited by the disclosed examples and other variations may be derived therefrom by a person skilled in the art without departing from the scope of protection of the invention as defined by the following patent claims.

The following is a summary list of reference numerals and the corresponding structure used in the above description of the invention:
1 holder
2 half body
4 half body
5 overall hollow body
6 holding section
8,8′ fastening section
10 through opening
12 through opening
14 recess
14.1 inner contour
15 screw-fastening element
16 nut
17 further recess
17.1 further inner contour
18 cord
18.1 noose
18.2 first cord end
18.3 second cord end
20 exit opening
22 longitudinal opening
24 holding opening
26 inner profile
28 rib
30 longitudinal rib
32 circumferential rib
34 pin
36 pin opening
38 wall
40 cord holder
42 first clamping body
42.1 cord guiding body
42.2 deflecting section
44, 44′ second clamping body
44.1 cord guiding body
44.2 deflecting section
46 guide
48 pin
50 slot
52 receptacle
54 inner wall
56 outer wall section
58,58′ reinforcing rib
60 outer wall
62 guide rib
64 cord receiving space
66 outer contour
68 arrow
70 load

The invention claimed is:

1. A holder, comprising:
one holding section for receiving, guiding and/or holding at least one elongated object; and
one fastening section having a cord holder being of a self-fixing configuration.

2. The holder according to claim 1, further comprising a cord, wherein said cord holder is configured to self-fix said cord disposed in said one fastening section by an imposition of a load.

3. The holder according to claim 2, further comprising two half bodies, which, in an assembled state, form an overall hollow body having said one holding section and said one fastening section.

4. The holder according to claim 3, wherein at least one of said half bodies contains, in said fastening section, at least two clamping bodies, which are configured, when the load is imposed, to fix said cord between said at least two clamping bodies with a clamping action and/or to fix said cord in a fixed position on said at least two clamping bodies.

5. The holder according to claim 4, wherein said at least two clamping bodies includes a first clamping body disposed in a fixed location in said fastening section.

6. The holder according to claim 5, wherein said first clamping body is configured as a cord guiding body.

7. The holder according to claim 5, wherein said at least two clamping bodies include a second clamping body disposed movably in said one fastening section or is placed loosely in said one fastening section before said cord is fixed with the clamping action.

8. The holder according to claim 7, wherein said second clamping body is placed in a noose of said cord placed in said one fastening section.

9. The holder according to claim 4, wherein said clamping bodies are formed in said one fastening section and disposed relative to one another such that said cord is guided in a meandering way around said clamping bodies.

10. The holder according to claim 3, wherein each of said half bodies has an axially extending, semicircular longitudinal opening formed therein in said one holding section, wherein, in the assembled state of said half bodies, each said axially extending, semicircular longitudinal opening forms a holding opening for the at least one elongated object to be held.

11. The holder according to claim 1, wherein said self-fixing configuration is a self-clamping configuration.

12. The holder according to claim 2, wherein said cord holder is configured to self-fix said cord by fixing said cord with a clamping action.

13. A charging column for an electric vehicle, the charging column comprising:
a charging cable;
a cord hanger configuration; and
at least one said holder according to claim 2, wherein said charging cable is disposed partially in said one holding section of said at least one holder, and a free end of said cord in said at least one holder is secured on said cord hanger arrangement.

14. The charging column according to claim 13, wherein said cord hanger configuration has at least one joint or hinge, which are configured to extend said cord hanger configuration in response to a pulling force acting on the charging cable.
